(19) United States
(12) Patent Application Publication
(10) Pub. No.: US 2015/0170249 A1
(43) Pub. Date: Jun. 18, 2015

(54) ITEM SEARCH AND REFINEMENT USING WEARABLE DEVICE

(71) Applicant: eBay Inc., San Jose, CA (US)

(72) Inventor: Oliver Nicholas Cockcroft, Los Gatos, CA (US)

(73) Assignee: EBAY INC., SAN JOSE, CA (US)

(21) Appl. No.: 14/105,747

(22) Filed: Dec. 13, 2013

(51) Int. Cl. G06Q 30/06

(52) U.S. Cl. CPC G06Q 30/0627

(57) ABSTRACT

A system and method of item search and refinement using a wearable device are described. In some embodiments, identifying information of a product is captured using an information capture device on a wearable device. The identifying information is transmitted from the wearable device to a computing device separate from the wearable device. The wearable device receives initial product information for the product. The initial product information comprises a plurality of item listings and refinement options for the plurality of item listings. Audio input is captured using an audio capture device on the wearable device. The audio input corresponds to a selection of one of the refinement options. A representation of the audio input is transmitted from the wearable device to the computing device. Subsequent product information for the product is received. The subsequent product information is different from the initial product information and is based on the selected refinement option.

### TECHNICAL FIELD

The present application relates generally to the technical field of data processing, and, in various embodiments, to systems and methods of item search and refinement using a wearable device.

### BACKGROUND

When spontaneously encountering a product of interest in a physical store, shoppers are limited in their ability to acquire additional information about the product by what devices they currently have with them or are readily available. Laptop computers, tablet computers, and even smartphones are not always readily available. As a result, shoppers may be deprived of the ability to perform shopping related activities for the product of interest.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publication system, in accordance with some embodiments;

FIG. 3 is a block diagram depicting various tables that may be maintained within a database, in accordance with some embodiments;

FIG. 4 is a block diagram illustrating components of an item search and refinement system, in accordance with some embodiments;

FIGS. 5A-5C illustrate a wearable device during different stages of a method of item search and refinement;

FIG. 6 is a flowchart illustrating a method of item search and refinement, in accordance with some embodiments;

FIG. 7 is a flowchart illustrating a method of item search and refinement, in accordance with some embodiments; and

FIG. 8 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes systems and methods of item search and refinement using a wearable device. In some embodiments, a system communicatively links a wearable device with an application or service on one or more other computing devices (e.g., a watch to a smartphone/tablet app, or a watch to API services). Once linked, any scans of a product that the wearable device makes with its image capture system, or other information capture system, can be sent via data connection to the linked app/service. The service can return data about the product scanned (e.g., name, brand, description, price, availability, etc.). The wearable device can display key information to the user that the user could interact with via voice or touch. Such information can include refinement and aspect options, thereby enabling the user to make refinement and aspect selections regarding the product. Using a native speech-to-text API, the system can interpret speech selections made by the user and give appropriate feedback based on the user's selections or commands, such as updating the item price and availability information to match the new filters selected by the user. At any point post scan, the user can swap to other devices (e.g., laptop computer, desktop computer, smartphone, tablet computer) and see the information on the scanned items and continue his or her shopping experience using that device.

In some embodiments, a computer-implemented method comprises capturing identifying information of a product using an information capture device on a wearable device, transmitting the identifying information from the wearable device to a computing device separate from the wearable device, and then receiving, by the wearable device, initial product information for the product. The initial product information can comprise a plurality of item listings and refinement options for the plurality of item listings. Audio input can then be captured using an audio capture device on the wearable device. The audio input can correspond to a selection of one of the refinement options. A representation of the audio input can then be transmitted from the wearable device to the computing device. Subsequent product information for the product can then be received. The subsequent product information can be different from the initial product information and can be based on the selected refinement option. In some embodiments, the wearable device comprises a watch.

In some embodiments, the computing device comprises a mobile device having an application configured to: receive the identifying information from the wearable device; retrieve the initial product information from a remote server using the identifying information; transmit the initial product information to the wearable device; receive the representation of the audio input from the wearable device; retrieve the subsequent product information from the remote server using the representation of the audio input; and transmit the subsequent product information to the wearable device. In some embodiments, the mobile device is a smartphone.

In some embodiments, capturing the identifying information of the product comprises scanning a barcode using a built-in camera on the wearable device. In some embodiments, the refinement options comprise at least one of color options for the item listings, size options for the item listings, and price options for the item listings. In some embodiments, the subsequent product information comprises price information or availability information corresponding to the selected refinement option. In some embodiments, the method further comprises concurrently storing multiple instances of captured identifying information on the wearable device. In some embodiments, the wearable device transmits the identifying information, receives the initial product information, transmits the representation of the audio input, and receives the subsequent product information without directly connecting to the Internet.

In some embodiments, the method further comprises prompting a user of the wearable device to provide confirmation audio input to confirm an action to be performed for the product on a remote server. In some embodiments, the action comprises requesting to purchase an item of one of the item listings.

In some embodiments, the method further comprises providing the subsequent product information for the product to a user of the wearable device. In some embodiments, providing the subsequent product information comprises displaying the subsequent product information on a screen of the wearable device.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

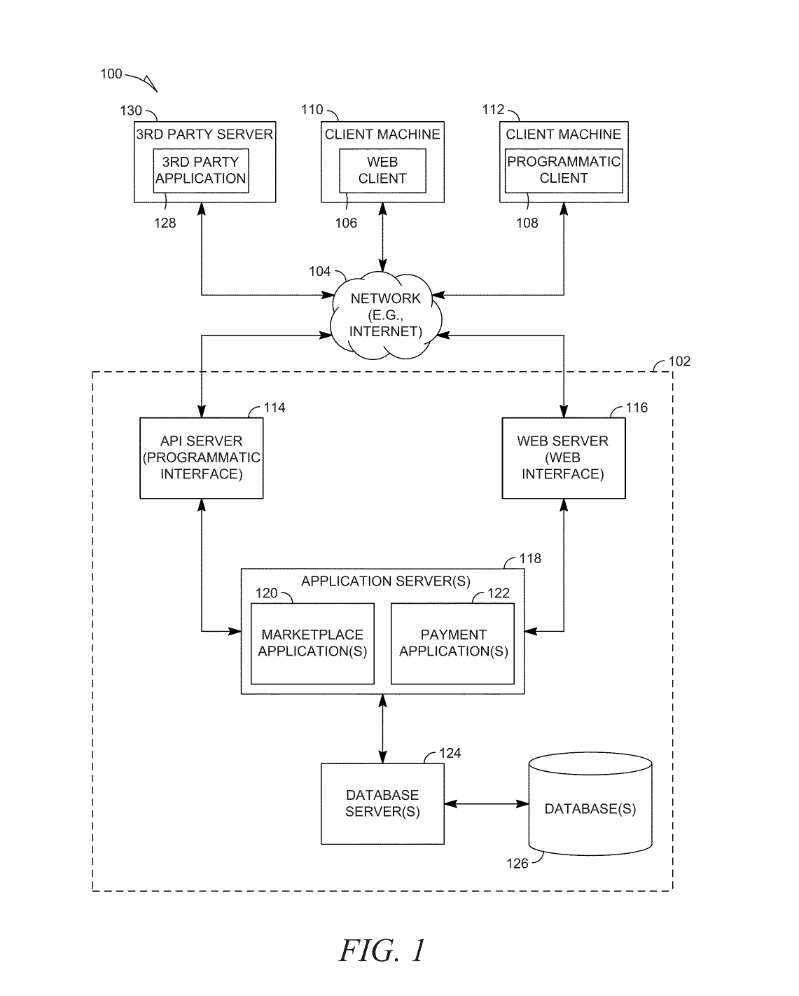

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

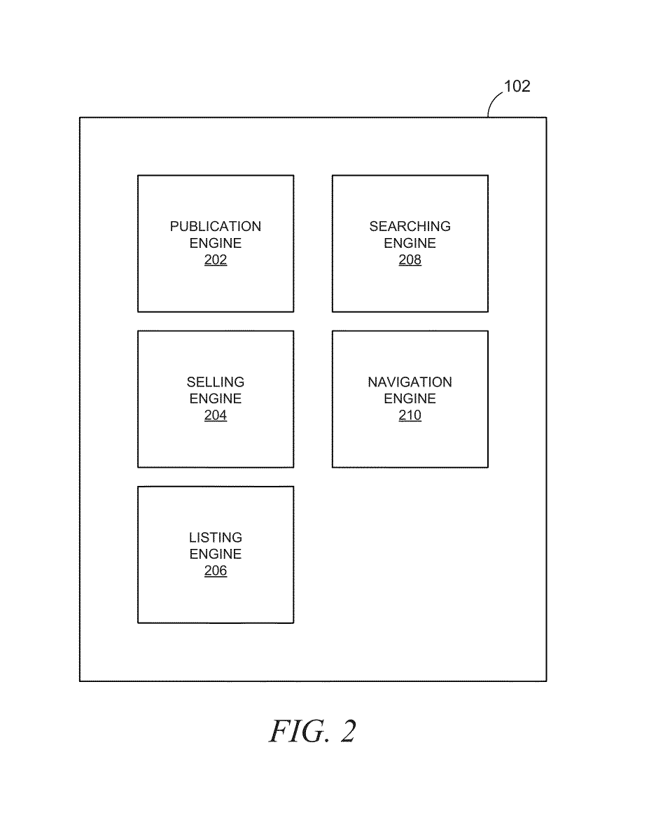

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 may also allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 208 may record the query (e.g., keywords) and any subsequent user actions and behaviors (e.g., navigations).

The searching engine 208 also may perform a search based on the location of the user. A user may access the searching engine 208 via a mobile device and generate a search query. Using the search query and the user's location, the searching engine 208 may return relevant search results for products, services, offers, auctions, and so forth to the user. In one example, the searching engine 208 can constrain search results to products that are determined to be available in a specific store that the user might be in at the time or to stores within a certain distance of the user's location. The searching engine 208 may identify relevant search results both in a list form and graphically on a map. Selection of a graphical indicator on the map may provide additional details regarding the selected search result. In some embodiments, the user may specify as part of the search query a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listings is reached. Various other navigation applications within the navigation engine 210 may be provided to supplement the searching and browsing applications. The navigation engine 210 may record the various user actions (e.g., clicks) performed by the user in order to navigate down the category tree.

Additional modules and engines associated with the networked system 102 are described below in further detail. It should be appreciated that modules or engines may embody various aspects of the details described below.

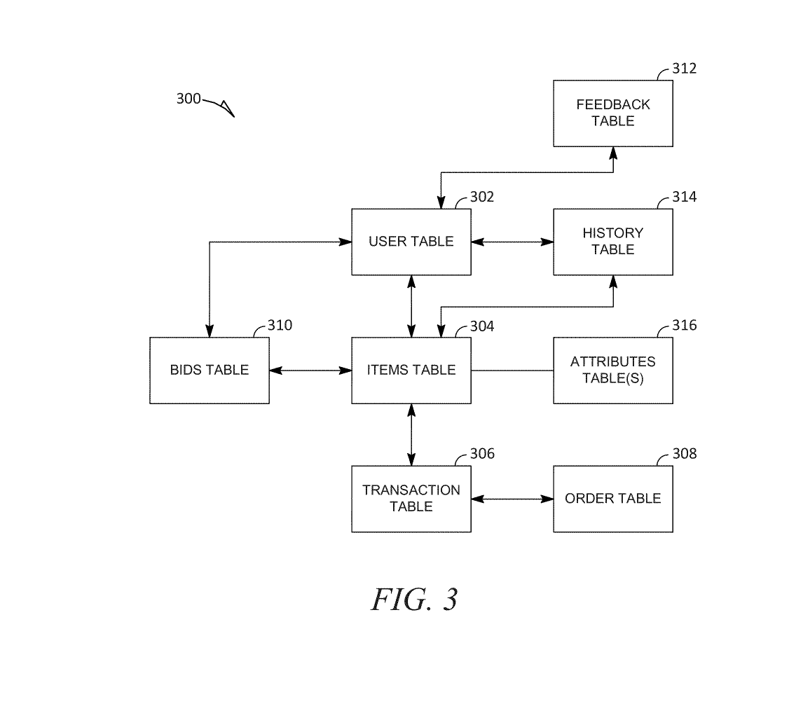

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, may be associated with one or more transactions for which records exist within the transaction table 306.

Bid records within a bids table 310 each relate to a bid received at the networked system 102 in connection with an auction-format listing supported by an auction application. A feedback table 312 is utilized by one or more reputation applications, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, with the currency attribute identifying the currency of a price for the relevant item as specified by a seller.

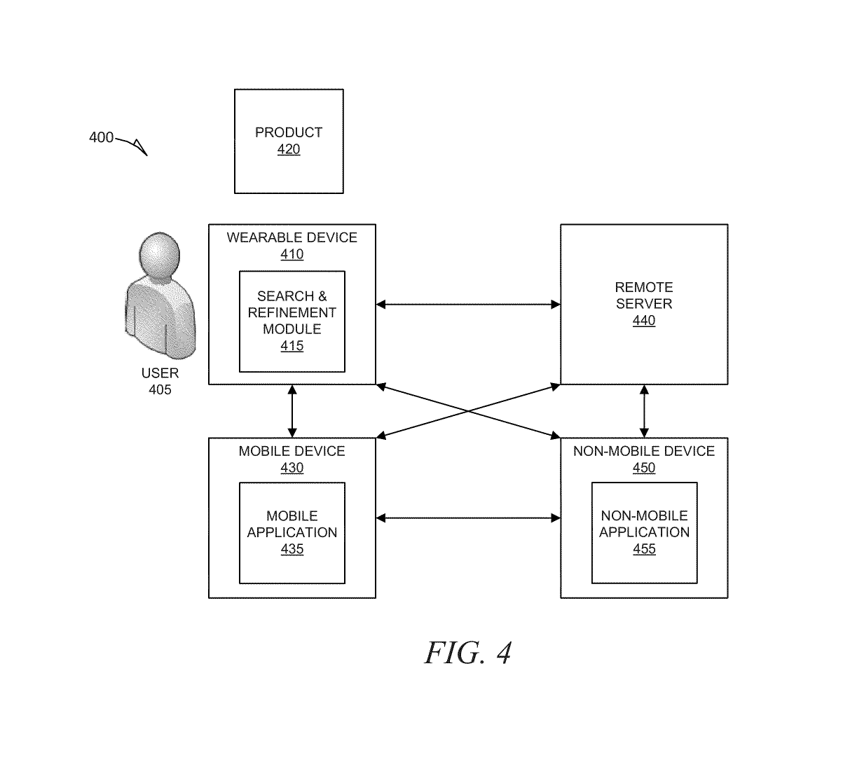

FIG. 4 is a block diagram illustrating components of an item search and refinement system 400, in accordance with some embodiments. The item search and refinement system 400 comprises a wearable device 410. The wearable device 410 can be any device configured to be worn by a user 405 on his or her body. In some embodiments, the wearable device 410 is a wrist-based device capable of being worn on the wrist of the user 405. In some embodiments, the wearable device 410 is a watch having one or more straps. In some embodiments, the wearable device 410 is configured to be worn using other attachment methods. For example, in some embodiments, the wearable device 410 is configured to be worn by the user 405 via one or more clips of pins, such as with a broach or a badge. It is contemplated that other types of wearable devices 410 and attachment methods are also within the scope of the present disclosure.

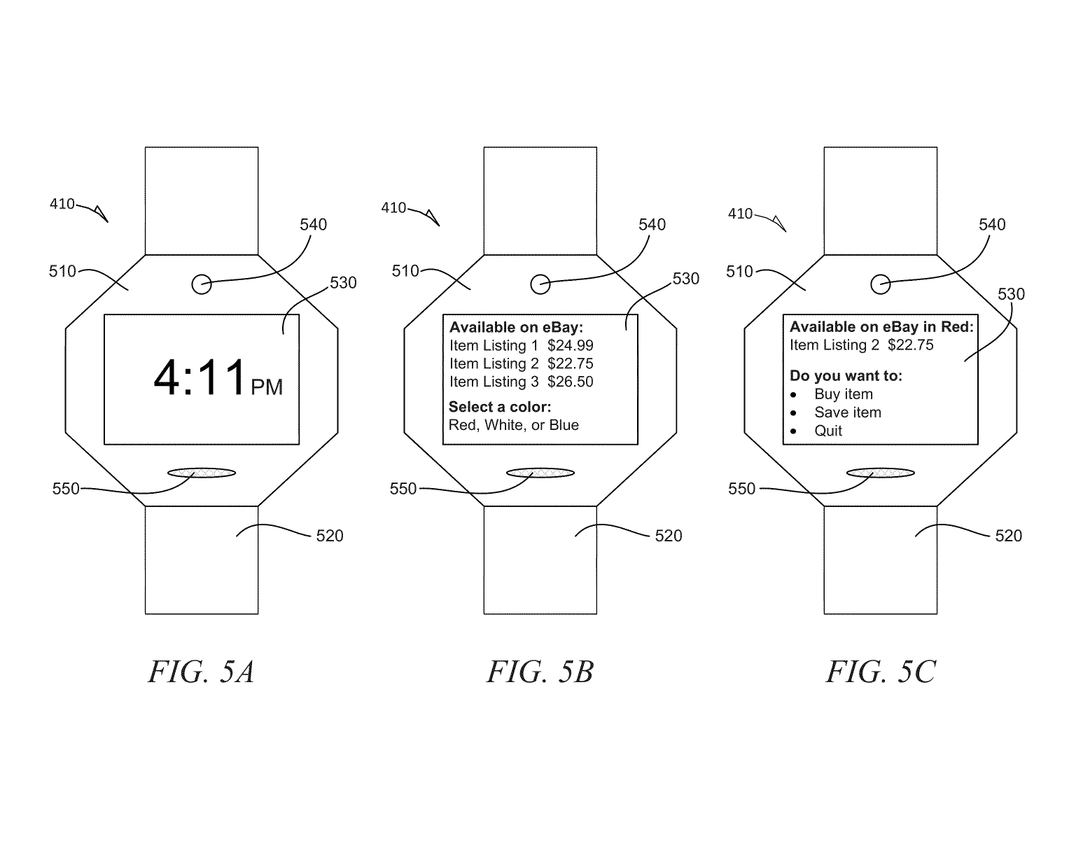

FIGS. 5A-5C illustrate the wearable device 410 as a watch in accordance with some embodiments. Accordingly, the wearable device 410 can comprise a body 510 and one or more straps 520 for securing the body of the watch to a wrist of the user 405. The wearable device 410 can comprise a display screen 530 for displaying information. In FIG. 5A, the display screen 530 displays the time of day (e.g., 4:11 PM). The wearable device 410 can also comprise an information capture device 540 configured to capture identifying information of a product 420. In some embodiments, the information capture device 540 comprises an image capture device, such as a built-in camera, configured to capture visual input. In some embodiments, the information capture device 540 comprises a radio frequency identification (RFID) reader configured to receive identifying information from an RFID tag (e.g., an RFID tag on the product 420). The RFID reader can be an active reader or a passive reader. Other types of information capture devices 540 are also within the scope of the present disclosure. The wearable device 410 can also comprise an audio capture device 550, such as a built-in microphone, configured to capture audio input.

In some embodiments, the wearable device 410 performs the functions disclosed herein via a software application installed on it. The user 405 can initiate the features disclosed herein by activating the software application on the wearable device 410. In some embodiments, the wearable device 410 comprises a search and refinement module 415 configured to perform the operations disclosed herein.

In some embodiments, the item search and refinement system 400 enables the user 405 to capture identifying information of a product 420 (e.g., clothing, toys, tools, consumer electronics, etc.) while shopping at a physical retail location. In some embodiments, the user 405 uses wearable device 410 to capture the identifying information of the product 420 using an information capture device 540 on the wearable device 410. The information capture device 540 may comprise a built-in camera or an RFID reader or both. Other types of information capture devices 540 are also within the scope of the present disclosure. In some embodiments, the identifying information comprises a barcode (e.g., a Quick Response (QR) code) that the user 405 scans with the information capture device of the wearable device 410. In some embodiments, the identifying information comprises an RFID signal from an RFID tag on or next to the product 420.

In some embodiments, the search and refinement module 415 is configured to transmit the identifying information from the wearable device 410 to a computing device separate from the wearable device 410. The computing device may comprise a mobile device 430. Examples of a mobile device include, but are not limited to, a smartphone and tablet computer. Other types of mobile devices 430 are also within the scope of the present disclosure. The mobile device 430 can comprise a mobile application 435 configured to receive the identifying information from the wearable device 410, and to retrieve initial product information from a remote server 440 using the identifying information.

In some embodiments, the remote server 440 is part of a network-based marketplace or publication system on which items are listed for sale, such as with networked system 102 in FIG. 1. The remote server 440 can use the identifying information to find information for a matching or otherwise corresponding item or product for sale. For example, if a barcode is scanned by the wearable device 410, and the scanned representation of the barcode is transmitted to the mobile device 430, which then transmits the scanned representation of the barcode to the remote server 440, then the remote server 440 can search one or more databases (e.g., database(s) 126 in FIG. 1) for items that correspond to the scanned barcode. Information about the item can be retrieved from the one or more databases, this retrieved information can form the initial product information and may include information such as title, brand, description, price, and availability. This information can also include refinement options. Refinement options are aspects of the product 420 that can be varied, such as size and color. It is contemplated that other refinement options are also within the scope of the present disclosure. The remote server 440 can then transmit the initial product information to the mobile device 430, which can then transmit the initial product information to the search and refinement module 415 on the wearable device 410. In alternative embodiments, the search and refinement module 415 can retrieve the initial product information directly from the remote server 440 without using the mobile device 430.

The search and refinement module 415 can present the initial product information, including the refinement options, to the user 405. In some embodiments, the search and refinement module 415 displays the initial product information on the display screen 530 of the wearable device 410. FIG. 5B illustrates one example of initial product information being displayed on the display screen 530 of the wearable device. In this example, the initial product information comprises item listings (Item Listing 1, Item Listing 2, Item Listing 3) corresponding to the product 420 along with corresponding prices. The item listings comprise items for sale. In some embodiments, the item listings comprise items for sale by different sellers (e.g., Item Listing 1 for sale by Seller 1, Item Listing 2 for sale by Seller 2, Item Listing 3 for sale by Seller 3).

The initial product information also includes selectable refinement options in the form of selectable color options (Red, White, Blue) from which the user 405 can make a selection. It is contemplated that other refinement options are also within the scope of the present disclosure. For example, in some embodiments, the refinement options can include price ranges or restrictions, size options, and/or other product options.

In some embodiments, the search and refinement module 415 can present the initial product information to the user 405 without the use of the display screen 530. For example, the search and refinement module 415 can provide the initial product information in the form of audio output. Other forms of presenting the initial product information to the user 405 are also within the scope of the present disclosure.

In some embodiments, the search and refinement module 415 is configured to receive input corresponding to a selection by the user 410 of one of the refinement options. In some embodiments, this input can be received via a touch screen on the wearable device. In some embodiments, this input is received in the form of audio input via the audio capture device 550 on the wearable device 410. For example, the user 405 can simply speak his or her selection into a built-in microphone on the wearable device 410.

A representation of the input corresponding to the selection by the user 410 can then be transmitted from the wearable device 410 to the computing device, such as the mobile device 430 or the remote server 440. In some embodiments, this representation comprises audio data captured by the audio capture device 550 on the wearable device 410. In some embodiments, this representation comprises a text translation of audio input captured by the audio capture device 550. This text translation of the audio input can be generated using a speech-to-text API configured to interpret speech selections or instructions provided by the user 405. The speech-to-text translation can be performed on the wearable device 410 or on the computing device (e.g., on the mobile device 430 or the remote server 440).

The computing device can then use the representation of the input corresponding to the selection by the user 410 to retrieve subsequent product information. The subsequent product information can then be transmitted to the wearable device 410, where it can be presented to the user 405. The subsequent product information is different from the initial product information. In some embodiments, the subsequent product information is an update of the initial product information. For example, in FIG. 5C, the subsequent product information is displayed to the user 405 on display screen 530 after the user 405 has selected Red as the color option in FIG. 5B. As a result, it is determined that Item Listing 1 and Item Listing 3 do not satisfy this refinement option selection by the user 405 (e.g., Item Listing 1 and Item Listing 3 are not available in Red), and, therefore, the subsequent product information in FIG. 5C reflects the fact that only Item Listing 2 is available in Red at a particular marketplace (e.g., eBay).

The subsequent product information can also include additional selection options for the user. For example, in FIG. 5C, the subsequent product information comprises selectable action options of buying the item of Item Listing 2, saving the item to the account of the user for later viewing, or quitting the application. Other selection options are within the scope of the present disclosure. In some embodiments, any information captured or received by the search and refinement module 415 or the wearable device 410 can be automatically saved. This automatic saving of information can be triggered by the capturing or reception of the information, or can be time-based (e.g., automatic saving of information every 15 minutes). Furthermore, it is contemplated that multiple types of refinement options can be presented to the user 405 during the query of the product 420. The multiple types of refinement options can be presented together or in series one after the other. For example, the search and refinement module 415 can present pricing options, size options, and color options concurrently, or one after the other in an ordered sequence. Other configurations are also within the scope of the present disclosure.

In some embodiments, the user 405 may be prompted to confirm a requested action, such as buying an item or saving an item. The search and refinement module 415 can prompt the user to provide voice confirmation of the requested action, and voice recognition techniques can be employed by the search and refinement module 415 on the wearable device 410 or on the computing device (e.g., mobile device 430 or remote server 440) to authenticate the request.

As seen in FIG. 4, search and refinement module 415 on wearable device 410 can be configured to transmit and receive data to and from a variety of different devices. Accordingly, a variety of different communication configurations are within the scope of the present disclosure. In some embodiments, wearable device 410 communicates directly with remote server 440. In some embodiments, wearable device 410 communicates directly with mobile device 430, which can then communicate with remote server 440 and relay information retrieved from remote server 440 back to wearable device 410 or present the retrieved information to the user 405 using its own data presentation device(s) (e.g., a display screen on mobile device 430 or a speaker on mobile device 430). In some embodiments, wearable device 410 communicates directly with a non-mobile device 450. Non-mobile device 450 can include, but is not limited to, a laptop computer or a desktop computer. Non-mobile device 450 can then communicate with remote server 440 and relay information retrieved from remote server 440 back to wearable device 410 or present the retrieved information to the user 405 using its own data presentation device(s) (e.g., a display screen on non-mobile device 450 or a speaker on mobile device 450). In some embodiments, mobile device 430 can communicate with non-mobile device 450 regarding any of the previously discussed information.

In some embodiments, search and refinement module 415 can store any of the captured identifying information for later use. For example, user 405 can use wearable device 410 to scan multiple products while shopping at a physical retail location. The multiple instances of captured identifying information corresponding to the scanned products can be concurrently stored by the wearable device 410. At a later time (e.g., two hours later), the user 405 can then transmit or upload the identifying information to another computing device, such as mobile device 430, remote server 440, or non-mobile device 450.

In some embodiments, wearable device 410 can be characterized by an absence of Internet access. Accordingly, in some embodiments, the wearable device transmits the identifying information, receives the initial product information, transmits the representation of the audio input, and receives the subsequent product information without directly connecting to the Internet. In some embodiments, wearable device 410 communicates with other computing devices using a physical data connection. Examples of a physical data connection include, but are not limited to, a Universal Serial Bus (USB) connection. In some embodiments, wearable device 410 communicates with other computing devices using wireless communication. Examples of wireless communication include, but are not limited to, Wi-Fi communication or Bluetooth communication. It is contemplated that other communication configurations are also within the scope of the present disclosure.

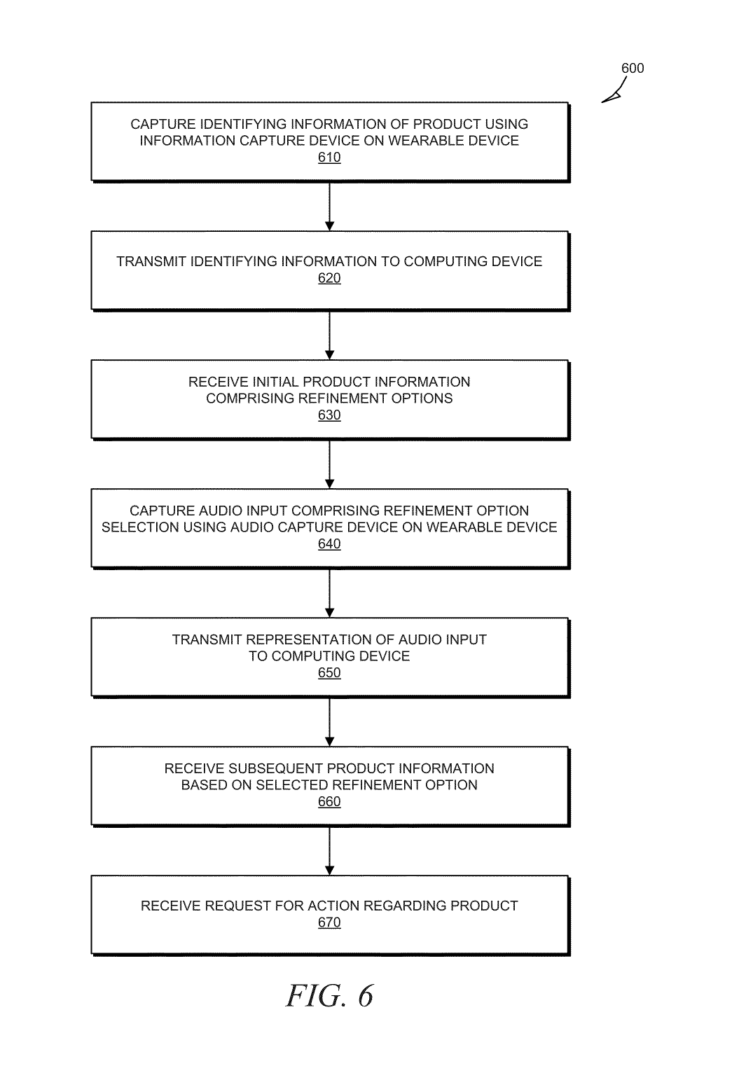

FIG. 6 is a flowchart illustrating a method 600 of item search and refinement, in accordance with some embodiments. The operations of method 600 may be performed by a system or modules of a system (e.g., search and refinement module 415 in FIG. 4). At operation 610, identifying information of a product 420 is captured using an information capture device (e.g., a built-in camera or RFID reader) on a wearable device 410. At operation 620, the identifying information is transmitted from the wearable device 410 to a computing device (e.g., mobile device 430, remote server 440, or non-mobile device 450) separate from the wearable device 410. At operation 630, initial product information for the product 420 is received by the wearable device 410. The initial product information can comprise one or more item listings corresponding to the product 420, as well as refinement options for the product 420. At operation 640, audio input is captured using an audio capture device 550 on the wearable device 410. The audio input can correspond to a selection of one of the refinement options. At operation 650, a representation of the audio input is transmitted from the wearable device 410 to the computing device. At operation 660, subsequent product information for the product 420 is received. The subsequent product information is different from the initial product information and is based on the selected refinement option. At operation 670, a request for an action regarding the product 420 or an item listing corresponding to the product 420 can be received. Examples of such requests include, but are not limited to, a request to buy an item corresponding to the product 420 and a request to save an item corresponding to the product 420. A confirmation or authentication process can be performed as a condition for carrying out the request.

In some embodiments, the method 600 can include multiple cycles of receiving product information with refinement options, capturing input comprising a refinement option selection, transmitting a representation of the input to a computing device, and receiving product information based on the selected refinement option. For example, during the first cycle, the user 405 can be presented with price options for a product 420. Subsequent to selecting a price option, the user 405 can be presented with color options for the product 420. The selection of certain options in one instance of product information can determine or otherwise influence what options will be presented to the user 405 in a subsequent instance of product information. It is contemplated that the operations of method 600 may incorporate any of the other features disclosed herein.

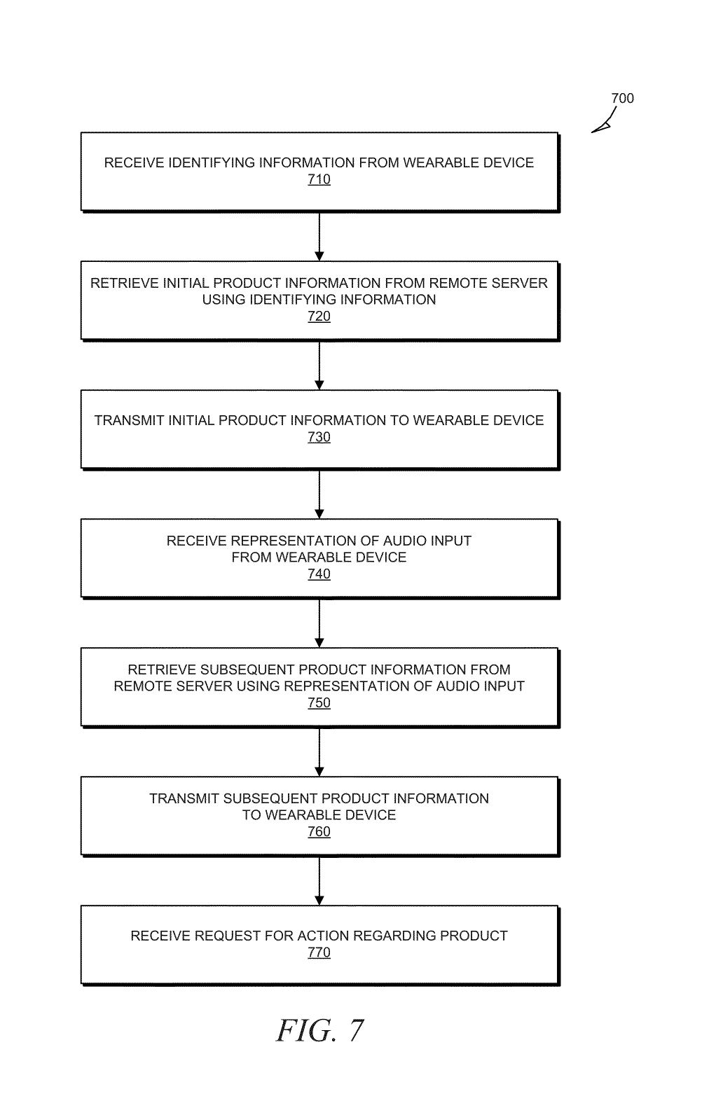

FIG. 7 is a flowchart illustrating a method 700 of item search and refinement, in accordance with some embodiments. The operations of method 700 may be performed by a system or modules of a system, such as by mobile application 435 on mobile device 435 in FIG. 4, or by a similar non-mobile application 455 on non-mobile device 450). At operation 710, identifying information of a product 420 is received from a wearable device 410. At operation 720, initial product information is retrieved from a remote server 440 using the identifying information. The initial product information can comprise one or more item listings corresponding to the product 420, as well as refinement options for the product 420. At operation 730, the initial product information is transmitted to the wearable device 410. At operation 740, a representation of audio input is received from the wearable device 410. The audio input can correspond to a selection of one of the refinement options. At operation 750, subsequent product information is retrieved from the remote server 440 using the representation of the audio input. At operation 760, the subsequent product information is transmitted to the wearable device. At operation 770, a request for an action regarding the product 420 or an item listing corresponding to the product 420 can be received. Examples of such requests include, but are not limited to, a request to buy an item corresponding to the product 420 and a request to save an item corresponding to the product 420. A confirmation or authentication process can be performed as a condition for carrying out the request.

In some embodiments, the method 700 can include multiple cycles of receiving a representation of the input corresponding to a selected refinement option, retrieving product information based on the selected refinement option, and transmitting subsequent product information, such that the selection of certain options in one instance of product information can determine or otherwise influence what options will be presented to the user 405 in a subsequent instance of product information. It is contemplated that the operations of method 700 may incorporate any of the other features disclosed herein.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

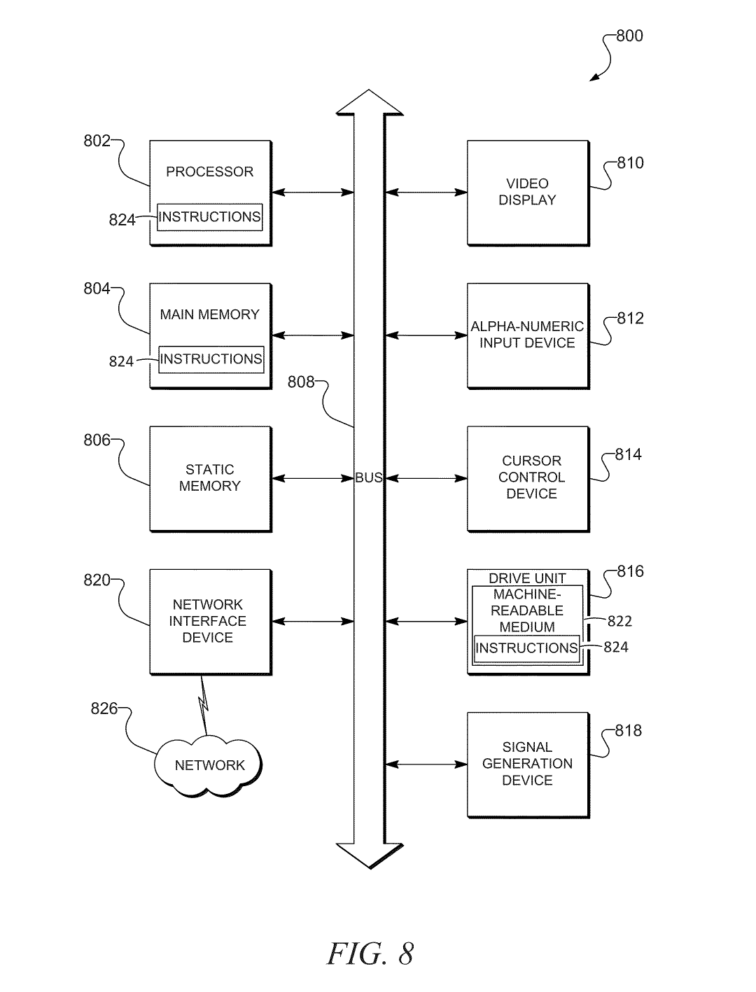

FIG. 8 is a block diagram of a machine in the example form of a computer system 800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation (or cursor control) device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media. The instructions 824 may also reside, completely or at least partially, within the static memory 806.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
capturing identifying information of a product using an information capture device on a wearable device;
transmitting the identifying information from the wearable device to a computing device separate from the wearable device;
receiving, by the wearable device, initial product information for the product, the initial product information comprising a plurality of item listings and refinement options for the plurality of item listings;
capturing audio input using an audio capture device on the wearable device, the audio input corresponding to a selection of one of the refinement options;
transmitting a representation of the audio input from the wearable device to the computing device; and
receiving subsequent product information for the product, the subsequent product information being different from the initial product information and based on the selected refinement option.

2. The method of claim 1, wherein the wearable device comprises a watch.

3. The method of claim 1, wherein the computing device comprises a mobile device, the mobile device having an application configured to:
receive the identifying information from the wearable device;
retrieve the initial product information from a remote server using the identifying information;
transmit the initial product information to the wearable device;
receive the representation of the audio input from the wearable device;
retrieve the subsequent product information from the remote server using the representation of the audio input; and
transmit the subsequent product information to the wearable device.

4. The method of claim 3, wherein the mobile device is a smartphone.

5. The method of claim 1, wherein capturing the identifying information of the product comprises scanning a barcode using a built-in camera on the wearable device.

6. The method of claim 1, wherein the refinement options comprise at least one of color options for the item listings and size options for the item listings.

7. The method of claim 1, wherein the subsequent product information comprises price information or availability information corresponding to the selected refinement option.

8. The method of claim 1, further comprising concurrently storing multiple instances of captured identifying information on the wearable device.

9. The method of claim 1, wherein the wearable device transmits the identifying information, receives the initial product information, transmits the representation of the audio input, and receives the subsequent product information without directly connecting to the Internet.

10. The method of claim 1, further comprising prompting a user of the wearable device to provide confirmation audio input to confirm an action to be performed for the product on a remote server.

11. The method of claim 10, wherein the action comprises requesting to purchase an item of one of the item listings.

12. The method of claim 1, further comprising providing the subsequent product information for the product to a user of the wearable device.

13. The method of claim 12, wherein providing the subsequent product information comprises displaying the subsequent product information on a screen of the wearable device.

14. A system comprising:
a wearable device having a memory and at least one processor;
an information capture device on the wearable device, the information capture device being configured to capture identifying information of a product;
an audio capture device on the wearable device, the audio capture device being configured to capture audio input; and
a search and refinement module, executable by the at least one processor, configured to:
transmit the identifying information to a computing device separate from the wearable device;
receive initial product information for the product, the initial product information comprising a plurality of item listings and refinement options for the plurality of item listings;
transmit a representation of the audio input to the computing device, the representation of the audio input corresponding to a selection of one of the refinement options; and
receive subsequent product information for the product, the subsequent product information being different from the initial product information and based on the selected refinement option.

15. The system of claim 14, wherein the wearable device comprises a watch.

16. The system of claim 14, further comprising the computing device, the computing device having an application configured to:
receive the identifying information from the wearable device;
retrieve the initial product information from a remote server using the identifying information;
receive the initial product information from the remote server;
transmit the initial product information to the wearable device;
receive the representation of the audio input from the wearable device;
retrieve the subsequent product information from the remote server using the representation of the audio input; and
transmit the subsequent product information to the wearable device.

17. The system of claim 14, wherein the information capture device comprises a built-in camera configured to capture the identifying information of the product by scanning a barcode.

18. The system of claim 14, wherein the refinement options comprise at least one of color options for the item listings and size options for the item listings.

19. The system of claim 14, wherein the subsequent product information comprises price information or availability information corresponding to the selected refinement option.

20. A non-transitory machine-readable storage device storing a set of instructions that, when executed by at least one processor, causes the at least one processor to perform a set of operations comprising:
capturing identifying information of a product using an information capture device on a wearable device;
transmitting the identifying information from the wearable device to a computing device separate from the wearable device;
receiving initial product information for the product, the initial product information comprising a plurality of item listings and refinement options for the plurality of item listings;
capturing audio input using an audio capture device on the wearable device, the audio input corresponding to a selection of one of the refinement options;
transmitting a representation of the audio input from the wearable device to the computing device; and
receiving subsequent product information for the product, the subsequent product information being different from the initial product information and based on the selected refinement option.
